(19) United States
(12) Patent Application Publication
(10) Pub. No.: US 2021/0184453 A1
(43) Pub. Date: Jun. 17, 2021

(54) NOZZLE DAMAGE REDUCTION IN GAS CIRCUIT BREAKERS FOR SHUNT REACTOR SWITCHING APPLICATIONS

(71) Applicant: MITSUBISHI ELECTRIC POWER PRODUCTS, INC., Warrendale, PA (US)

(72) Inventor: Takashi Yonezawa, Mars, PA (US)

(21) Appl. No.: 16/718,005

(22) Filed: Dec. 17, 2019

(51) Int. Cl. H02H 3/38

(52) U.S. Cl. CPC H02H 3/38

(57) ABSTRACT

Embodiments of the present disclosure provide a method for closing a gas circuit breaker (GCB) during energizing of a shunt reactor. In embodiments, the method comprises determining a phase angle from a bus voltage zero to a GCB main contact closing, and closing the gas circuit breaker using synchronous switching control (SSC) according to the phase angle. In embodiments, the gas circuit breaker (GCB) comprises an interrupter and a pre-insertion resistor, where the pre-insertion resistor is electrically coupled in parallel to the interrupter contacts. In embodiments, the GCB with the pre-insertion resistor is placed between the bus and the shunt reactor, and the pre-insertion resistor unit is placed in the same gas enclosure as the circuit breaker. The pre-insertion resistor is electrically inserted between the GCB interrupter contacts in its closing operation.

### FIELD

The embodiments described herein relate generally to circuit breakers and, more particularly, to nozzle damage reduction in gas circuit breakers for shunt reactor switching applications.

### BACKGROUND INFORMATION

A circuit breaker is an automatically operated electrical switch designed to protect an electrical circuit from damage caused by overload or short circuit. Its basic function is to detect a fault condition and interrupt current flow. Unlike a fuse, which operates once and then must be replaced, a circuit breaker can be reset (either manually or automatically) to resume normal operation. Circuit breakers are made in varying sizes, from small devices that protect an individual household appliance up to large switchgear designed to protect high voltage circuits feeding an entire city.

Shunt reactors are often used to compensate for the capacitive charging current in unloaded transmission lines. Shunt reactors may be connected directly to the line, but such application is relatively infrequent. More often, they are connected to the tertiary winding of a transformer, when compensation of a high-voltage line is required. Reactors are used to compensate for line capacitance when the line is lightly loaded, and are typically switched out as the load increases. Because the amount of compensation needed varies with loading on the line, shunt reactors are typically switched daily. The circuit breaker used for shunt reactor switching will thus experience a large number of operations.

Energization of shunt capacitor banks causes high amplitude inrush currents and an associated overvoltage in the local substation and a remote overvoltage at the receiving end of transmission lines connected to the substation. A modern GCB generally provides a very low probability of restrike for capacitive current interruption.

Controlled closing of shunt capacitor banks is used to minimize stress on the power system and its components. It also provides economic benefits such as elimination of a pre-insertion resistor or a fixed inductor and extension of the number of allowable operations before the nozzle and contacts of the GCB need to be replaced. Controlled closing is not normally applied to GCBs outside of high voltage (e.g., 362 kV, 550 kV) applications.

All circuit breakers exhibit a high probability of re-ignition during de-energization of shunt reactors for arcing times of less than a minimum arcing time. Controlled opening can avoid re-ignition over-voltages by separating the contact when the arcing time will be longer than the minimum arcing time while considering the relative importance of chopping overvoltage, which increases with an increase in arcing time. Since re-ignition over-voltages are normally more severe than chopping over-voltages, it is a common practice in SSC applications to increase the arcing time.

Controlled opening of shunt reactor banks can eliminate the re-ignition overvoltage, which has the potential to induce damage to the GCB such as nozzle puncture. It also provides economic benefits such as reduced possibility of damage to the reactor and extension of the number of operations before the nozzle and contact need to be replaced.

In view of the foregoing, it is therefore desirable to provide a combination of closing resistors and synchronous control in order to reduce and/or minimize interrupter nozzle damage in gas circuit breakers (GCB) for shunt reactor switching applications.

### SUMMARY

The present disclosure is directed to combining closing resistors and synchronous control to reduce and/or minimize interrupter nozzle damage in gas circuit breakers (GCB) for shunt reactor switching applications.

In embodiments, a method for closing a gas circuit breaker (GCB) during energizing of a shunt reactor comprises determining a phase angle from a bus voltage zero to a GCB main contact closing and closing the gas circuit breaker using synchronous switching control (SSC) according to the phase angle. In embodiments, the gas circuit breaker (GCB) comprises an interrupter and a pre-insertion resistor. In embodiments, the pre-insertion resistor is electrically coupled in parallel to the interrupter. In embodiments, the GCB with the pre-insertion resistor is placed between the bus and the shunt reactor, and the pre-insertion resistor unit is placed in the same gas enclosure as the circuit breaker. The pre-insertion resistor is electrically inserted between the GCB interrupter contacts in its closing operation. In embodiments, the phase angle is determined based at least in part on one or more of a pre-insertion resistor resistance value, an insertion time, a rate of decrease of dielectric strength (RDDS) for a pre-insertion resistor contact and the GCB main contact, or a shunt reactor rating. In embodiments, the insertion time is a difference between pre-insertion resistor contact and main contact closing time in a no-load closing operation. In embodiments, the phase angle represents a time at which main contacts of the GCB touch with its voltage zero between them.

Embodiments of the present disclosure are directed to a system comprising a shunt reactor, a gas circuit breaker (GCB) comprising an interrupter and a pre-insertion resistor, where the pre-insertion resistor is electrically coupled in parallel to the interrupter, and a synchronous switching control mechanism for closing the gas circuit breaker according to a phase angle from a bus voltage zero to a GCB main contact closing. In embodiments, the synchronous switching control mechanism and pre-insertion resistor minimize or eliminate damage to the interrupter nozzle caused by ignition arcs during energizing of the shunt reactor. The GCB with the pre-insertion resistor is placed between the bus and the shunt reactor, and the pre-insertion resistor unit is placed in the same gas enclosure as the circuit breaker. The pre-insertion resistor is electrically inserted between the GCB interrupter contacts in its closing operation.

Other systems, methods, features and advantages of the example embodiments will be or will become apparent to one with skill in the art upon examination of the following figures and detailed description.

### BRIEF DESCRIPTION OF THE FIGURES

The details of the example embodiments, including structure and operation, may be gleaned in part by study of the accompanying figures, in which like reference numerals refer to like parts. The components in the figures are not necessarily to scale, emphasis instead being placed upon illustrating the principles of the invention. Moreover, all illustrations are intended to convey concepts, where relative sizes, shapes and other detailed attributes may be illustrated schematically rather than literally or precisely.

FIG. 1 illustrates a conventional shunt reactor GCB closing process;

FIG. 2 illustrates an exemplary shunt reactor GCB closing process, according to embodiments of the present disclosure;

FIG. 3 illustrates exemplary nozzle damage caused by an ignition arc, according to embodiments of the present disclosure;

FIG. 4A illustrates exemplary control closing without a pre-insertion resistor at zero voltage, for use with embodiments of the present disclosure;

FIG. 4B illustrates exemplary control closing without a pre-insertion resistor at peak voltage, for use with embodiments of the present disclosure;

FIG. 5 illustrates exemplary control closing with a pre-insertion resistor at 60% of peak voltage, for use with embodiments of the present disclosure;

FIG. 6A illustrates exemplary closing operation (voltage and current) by a GCB with a pre-insertion resistor, according to embodiments of the present disclosure; and

FIG. 6B illustrates exemplary closing operation (circuit diagrams) by a GCB with a pre-insertion resistor, according to embodiments of the present disclosure.

It should be noted that elements of similar structures or functions are generally represented by like reference numerals for illustrative purpose throughout the figures. It should also be noted that the figures are only intended to facilitate the description of the preferred embodiments.

### DETAILED DESCRIPTION

Each of the additional features and teachings disclosed below can be utilized separately or in conjunction with other features and teachings to combine closing resistors and synchronous control to reduce and/or minimize interrupter nozzle damage in gas circuit breakers (GCB) for shunt reactor switching applications. Representative examples of the present invention, which examples utilize many of these additional features and teachings both separately and in combination, will now be described in further detail with reference to the attached drawings. This detailed description is merely intended to teach a person of skill in the art further details for practicing preferred aspects of the present teachings and is not intended to limit the scope of the invention. Therefore, combinations of features and steps disclosed in the following detailed description may not be necessary to practice the invention in the broadest sense, and are instead taught merely to particularly describe representative examples of the present teachings.

Moreover, the various features of the representative examples and the dependent claims may be combined in ways that are not specifically and explicitly enumerated in order to provide additional useful embodiments of the present teachings. In addition, it is expressly noted that all features disclosed in the description and/or the claims are intended to be disclosed separately and independently from each other for the purpose of original disclosure, as well as for the purpose of restricting the claimed subject matter independent of the compositions of the features in the embodiments and/or the claims. It is also expressly noted that all value ranges or indications of groups of entities disclose every possible intermediate value or intermediate entity for the purpose of original disclosure, as well as for the purpose of restricting the claimed subject matter.

According to the IEEE and IEC standards, the maximum rated shunt reactor current is about 300 A for the rated voltage range 60 kV and above, which is far below the short-circuit current (several tens of kA) for a shunt reactor. As a result, when the shunt reactor current is interrupted, the interruption occurs over a short arc time. At this time, since a high recovery voltage is applied between the GCB arc contacts at the natural frequency of the shunt reactor, re-ignition occurs if there is not enough distance between the arc contacts. This arc discharge damages the interrupter nozzle and shortens its life. In addition, when the shunt reactor is energized, a high-voltage pre-discharge occurs depending on the GCB closing, and the interrupter nozzle is damaged. Damage to the nozzle leads to a decrease of withstand voltage performance and shortens the life of the arc chamber.

In the case of shunt reactor current interruption, the current is easily interrupted in short arcing times of 0.2˜0.3 cycles because shunt reactor current is low enough compared to fault currents. However, a gas circuit breaker (GCB) cannot withstand the recovery voltage at the short contact gap at arcing times of 0.2˜0.3 cycles, and therefore re-ignition occurs. One re-ignition is allowed by IEEE/IEC standards if interruption is successful at the next current zero (0.7˜0.8 cycles arcing time).

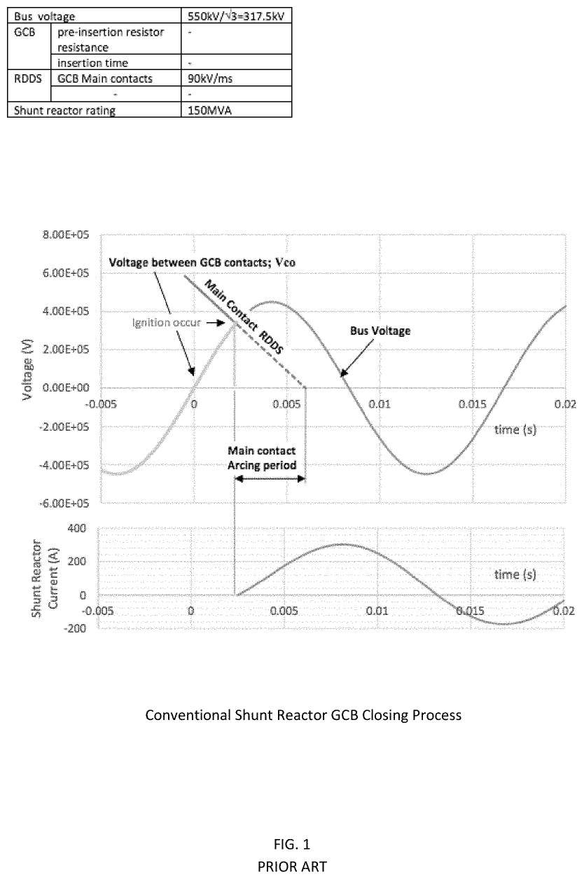

FIG. 1 illustrates a conventional shunt reactor GCB closing process. In FIG. 1, during shunt reactor de-energizing, synchronous switching control (SSC) is applied (circuit breaker opening) to perform circuit breaker opening phase control to avoid harmful ignition at high voltage. Also in FIG. 1, during shunt reactor energizing (circuit breaker closing), the circuit breaker closing phase (timing) control is implemented by applying synchronous switching control (SSC) to close the circuit breaker at bus voltage peak. Here, no closing control technique is applied to mitigate nozzle damage. That is, no measures are taken to reduce nozzle damage due to arcing at the time of shunt reactor energizing.

In conventional shunt reactor switching such as what is depicted in FIG. 1 and described above, damage to the nozzle during de-energization may be minimized by using synchronous switching control (SSC) to minimize or eliminate the re-ignition. However, no measures are taken to minimize damage to the nozzles for the shunt reactor energizing operation. For this reason, the GCB for the shunt reactor is not able to extend the life of the interrupter nozzle unlike other de-energizing. In other words, it requires more frequent replacement of parts than other interruption duty GCBs.

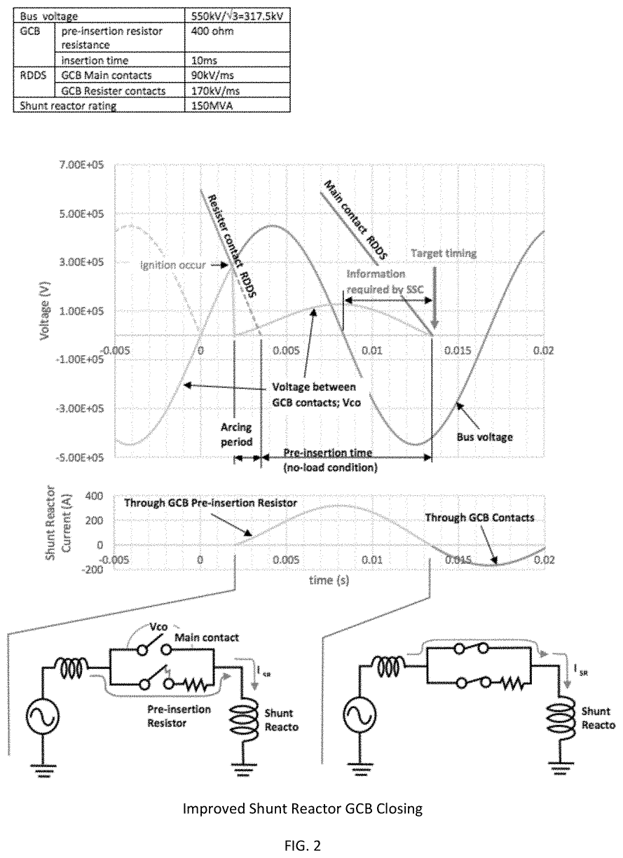

FIG. 2 illustrates an exemplary shunt reactor GCB closing process, according to embodiments of the present disclosure. In FIG. 2, a GCB with a pre-insertion resistor is applied for shunt reactor switching, and the closing phase is controlled by synchronous switching control (SSC).

In FIG. 2, the synchronous switching control (SSC) is accomplished by preparing a power supply that simulates the bus voltage, an equivalent circuit of the shunt reactor, and a circuit with a gas circuit breaker (GCB) comprising an interrupter and a pre-insertion resistor. In embodiments, the pre-insertion resistor is electrically coupled in parallel to the interrupter. In embodiments, the GCB with the pre-insertion resistor is placed between the bus and the shunt reactor, and the pre-insertion resistor unit is placed in the same gas enclosure as the circuit breaker. The pre-insertion resistor is electrically inserted between the GCB interrupter contacts in its closing operation.

Control closing information (a phase angle from bus voltage zero to GCB main contact closing) is determined based on the following parameters:
A pre-insertion resistor resistance value and insertion time, where the insertion time is a difference between resistor contact and main contact closing time in a no-load closing operation;
A rate of decrease of dielectric strength (RDDS) for the pre-insertion resistor contact and the main contact; and
A shunt reactor rating.

The control closing information for the shunt reactor energizing is determined by varying the close timing in the above described circuit in order to locate the timing at which the main contacts of the GCB touch with its voltage zero between them.

Finally, the control closing information is used for synchronous switching control (SSC) of the shunt reactor.

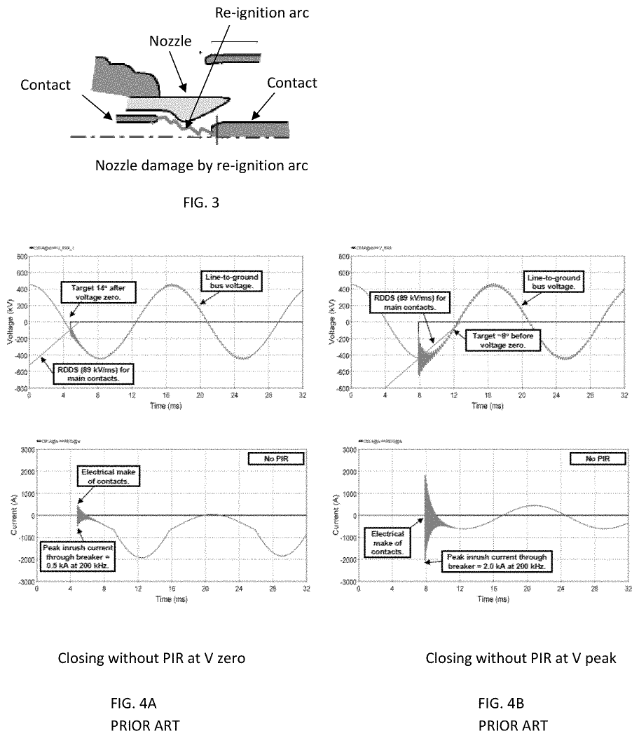

FIG. 3 illustrates exemplary nozzle damage caused by an ignition arc, according to embodiments of the present disclosure. If a gas circuit breaker (GCB) operates without an opening timing controller, the ignition randomly occurs and develops or contributes to damage of the nozzle. The nozzle is normally made of PTFE, and surrounds GCB contacts to control arc-quenching gas flow. Nozzle damage reduces the withstand capability to the recovery voltage of the interrupter and it limits the lifetime of a nozzle.

In addition to the influence of ignition during SHR de-energization, shunt reactor energization is also recognized as a contributor of nozzle damage. Comparisons of (a) nozzles taken from a site with GCBs in service with SHR energizing and interruption history and (b) a nozzle obtained by laboratory tests on GCBs that only experienced interruption under the same conditions, showed significant differences in damage between the nozzles. Though the nozzle from the site exhibited serious damage, only slight contamination was observed on the laboratory test nozzle. When the SHR is energized applying a synchronous switching controller (SSC), the GCB in SHR circuit is normally closed at the peak of system voltage to avoid SHR mechanical stress generated by offset current occurred at anything other than the voltage peak closing. But this practice accelerates the nozzle damage.

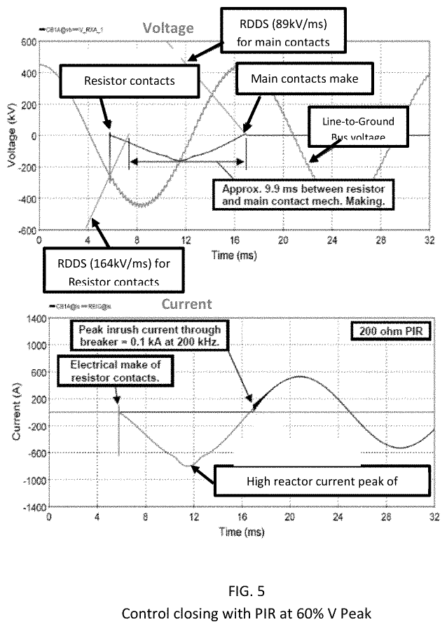

FIG. 4A illustrates exemplary control closing without a pre-insertion resistor at zero voltage, for use with embodiments of the present disclosure. In FIG. 4A, the most severe situation for a shunt reactor is shown whereby, when controlled closing is applied to a shunt reactor bank at voltage ˜0, and no pre-insertion resistor is used, high mechanical stress is generated on SHR caused by reactor core saturation (e.g., a high reactor current peak of ˜2 kA results).

FIG. 4B illustrates exemplary control closing without a pre-insertion resistor at peak voltage, for use with embodiments of the present disclosure. In FIG. 4B, the most severe situation for a nozzle of a GCB interrupter is shown whereby, when controlled closing is applied to a shunt reactor bank at peak voltage, a high inrush current peak occurs at 2 kA, resulting in GCB nozzle damage.

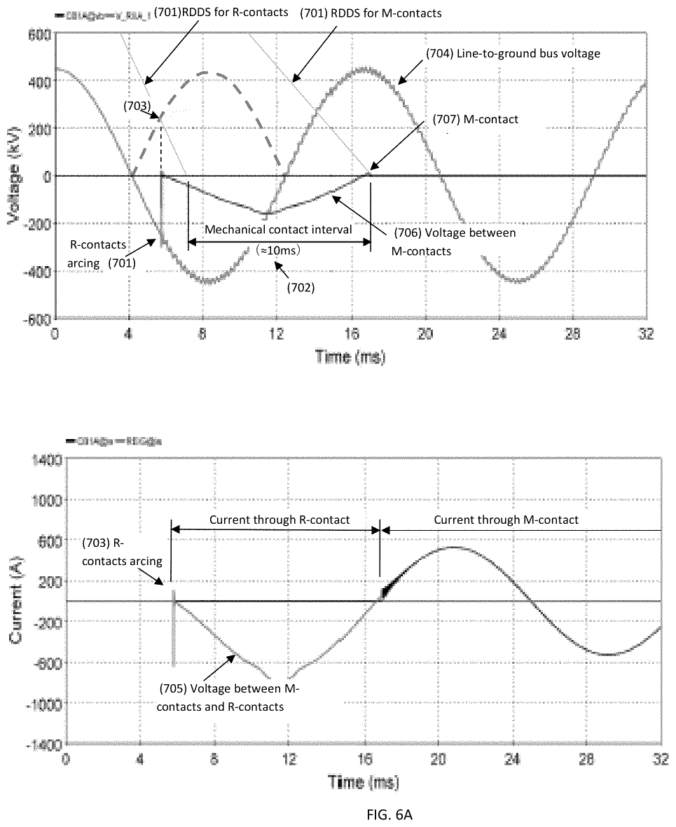

FIG. 5 illustrates exemplary control closing with a 200Ω pre-insertion resistor at 60% of peak voltage, for use with embodiments of the present disclosure. Embodiments of the present disclosure mitigate (i.e., reduce or minimize) GCB SHR nozzle damage through the use of equipment for improved SHR energizing and a GCB control scheme involving control closing at current zero (which is also equal to contact voltage zero). In embodiments, the equipment used for improved SHR energizing comprises a GCB with a 200Ω-400Ω pre-insertion resistor and an insertion time of ˜8-12 ms. This low resistance relaxes the control accuracy and makes low voltage closing possible. The equipment further comprises a synchronous switching controller for implementing a control scheme whereby closing occurs at a calculated resistor current zero.

Shown in FIG. 5, the exemplary control closing scheme results in nearly zero voltage electrical contact making for main contacts, and an inrush current of 0.1 kA.

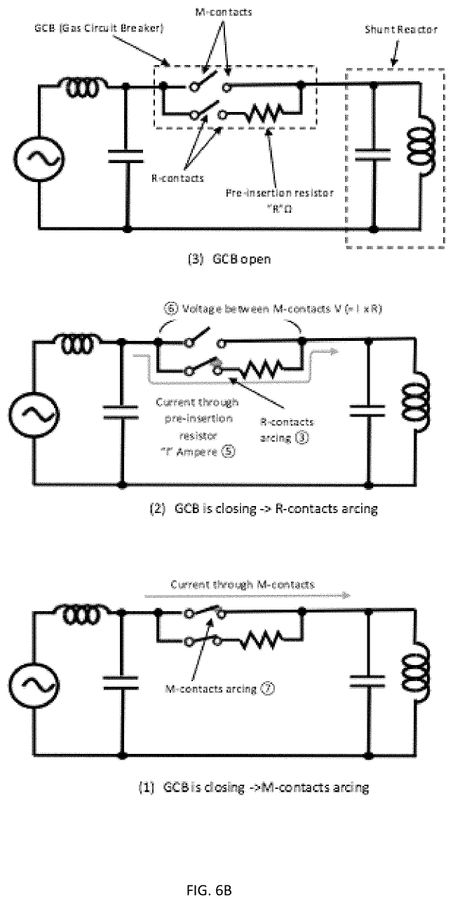

FIGS. 6A and 6B illustrate exemplary closing operation by a GCB with a pre-insertion resistor, according to embodiments of the present disclosure.

In FIGS. 6A and 6B, a closing command from a control room GCB operating mechanism starts to drive both moving the main contact (M-contact(s)) and Resistor contact (R-contact(s)) to a stationary contacts side. In this process, Dielectric strength between contacts of the R-contacts and the M-contacts decrease in the closing process. Characteristics (e.g., RDDS) are obtained by experiment and are expressed in FIG. 6A (701).

Shown in (3) of FIG. 6B, the GCB is open.

Shown in (2) of FIG. 6B, as the R-contacts are designed to make mechanical contact approximately 10 ms earlier than the M-contacts (702), the R-contacts arcing occurs (703) before M-contacts when the R-contacts dielectric strength becomes lower than the line-to-ground bus voltage (704).

Shown in (1) of FIG. 6B, next, current “I” (705) with a decaying DC current component starts to flow through a pre-insertion resistor to the shunt reactor. The GCB open M-contacts will then experience the voltage “V” (i.e., =I×R) (706). The main contact M-contacts RDDS value then becomes lower than the voltage mentioned above, and M-contacts arcing occurs (707). As mentioned above, if this voltage (e.g., V) is high, the GCB interrupter may have higher damage occur and thus shorten the nozzle life. Embodiments of the present disclosure minimize the voltage at which the M-contacts close (or make contact).

In the foregoing specification, the invention has been described with reference to specific embodiments thereof. It will, however, be evident that various modifications and changes may be made thereto without departing from the broader spirit and scope of the invention. For example, the reader is to understand that the specific ordering and combination of process actions shown in the process flow diagrams described herein is merely illustrative, unless otherwise stated, and the invention can be performed using different or additional process actions, or a different combination or ordering of process actions. As another example, each feature of one embodiment can be mixed and matched with other features shown in other embodiments. Features and processes known to those of ordinary skill may similarly be incorporated as desired. Additionally and obviously, features may be added or subtracted as desired. Accordingly, the invention is not to be restricted except in light of the attached claims and their equivalents.

1. A method for closing a gas circuit breaker (GCB) during energizing of a shunt reactor, the method comprising:
determining a phase angle from a bus voltage zero to a GCB main contact closing; and
closing the gas circuit breaker (GCB) using synchronous switching control (SSC) according to the phase angle.

2. The method of claim 1, wherein a pre-insertion resistor is electrically coupled between interrupter contacts of the GCB when the gas circuit breaker is closing.

3. The method of claim 2, wherein the phase angle is determined based at least in part on one or more of a pre-insertion resistor resistance value, an insertion time, a rate of decrease of dielectric strength (RDDS) for a pre-insertion resistor contact and the GCB main contact, or a shunt reactor rating.

4. The method of claim 3, wherein the insertion time is a difference between pre-insertion resistor contact and main contact closing time in a no-load closing operation.

5. The method of claim 1, wherein the phase angle represents a time at which main contacts of the GCB electrically couple with one another with voltage zero between them.

6. The method of claim 2, wherein the gas circuit breaker (GCB) with the pre-insertion resistor is placed between a bus and the shunt reactor.

7. The method of claim 2, wherein the gas circuit breaker (GCB) and pre-insertion resistor are housed within a common gas enclosure.

8. The method of claim 2, wherein a synchronous switching control (SSC) mechanism and the pre-insertion resistor minimize or eliminate damage to an interrupter nozzle of the gas circuit breaker (GCB) caused by ignition arcs during energizing of the shunt reactor.

9. The method of claim 3, wherein the pre-insertion resistor resistance is in a range of 200Ω-400 Ω.

10. The method of claim 3, wherein the insertion time is approximately 8-12 ms.

11. A system, comprising:
a shunt reactor;
a gas circuit breaker (GCB) comprising an interrupter and a pre-insertion resistor, wherein the pre-insertion resistor is electrically coupled in parallel to the interrupter; and
a synchronous switching control (SSC) mechanism for closing the gas circuit breaker according to a phase angle from a bus voltage zero to a GCB main contact closing.

12. The system of claim 11, wherein the gas circuit breaker (GCB) with the pre-insertion resistor is placed between a bus and the shunt reactor.

13. The system of claim 11, wherein the pre-insertion resistor is electrically coupled between interrupter contacts of the gas circuit breaker (GCB) when the gas circuit breaker (GCB) is closing.

14. The system of claim 11, wherein the gas circuit breaker (GCB) and pre-insertion resistor are housed within a common gas enclosure.

15. The system of claim 11, wherein the synchronous switching control (SSC) mechanism and pre-insertion resistor minimize or eliminate damage to an interrupter nozzle caused by ignition arcs during energizing of the shunt reactor.

16. The system of claim 11, wherein the phase angle is determined based at least in part on one or more of a pre-insertion resistor resistance value, an insertion time, a rate of decrease of dielectric strength (RDDS) for a pre-insertion resistor contact and the GCB main contact, or a shunt reactor rating.

17. The system of claim 16, wherein the insertion time is a difference between pre-insertion resistor contact and main contact closing time in a no-load closing operation.

18. The system of claim 11, wherein the phase angle represents a time at which main contacts of the GCB electrically couple with one another with voltage zero between them.

19. The system of claim 16, wherein the pre-insertion resistor resistance is in a range of 200Ω-400 Ω.

20. The system of claim 16, wherein the insertion time is approximately 8-12 ms.
